(19) United States
(12) Patent Application Publication
(10) Pub. No.: US 2025/0343364 A1
(43) Pub. Date: Nov. 6, 2025

(54) PHASED ARRAY WITH INCREASED ELEMENT OFFSET

(71) Applicant: Qorvo US, Inc., Greensboro, NC (US)

(72) Inventor: Curtis Crockett, San Diego, CA (US)

(21) Appl. No.: 19/194,812

(22) Filed: Apr. 30, 2025

Related U.S. Application Data
(60) Provisional application No. 63/641,440, filed on May 2, 2024.
(60) Provisional application No. 63/675,713, filed on Jul. 25, 2024.

(51) Int. Cl. H01Q 21/06; H01Q 3/26; H01Q 3/34

(52) U.S. Cl. CPC H01Q 21/061; H01Q 3/2611; H01Q 3/34

(57) ABSTRACT

A phased antenna array includes a number of split element unit cells arranged in an array having at least one row of split element unit cells. Each row is arranged relative to a horizontal row axis, where each split element unit cell comprises two split-fed antennas arranged substantially along a vertical column axis substantially normal to the row axis and having a phase center substantially along the column axis between the two split-fed antennas. The column axes of the split element unit cells of each row are substantially parallel, and the phase center of each split element unit cell in a row is offset vertically from the phase center of an adjacent split element unit cell in the row by a distance of more than half of a single element unit cell, up to and including 1.5 single element unit cells.

### CROSS-REFERENCE TO RELATED APPLICATION(S)

This application claims the priority benefit under 35 U.S.C. § 119(e) of U.S. Provisional Patent Application No. 63/675,713 filed Jul. 25, 2024, and U.S. Provisional Patent Application No. 63/641,440, filed May 2, 2024, the each of which of which is incorporated by reference as though fully set forth herein.

The subject matter of this patent application also may be related to the subject matter of U.S. patent application Ser. No. 18/601,689 entitled ARRAY LATTICE TECHNIQUES FOR HIGH SYMMETRY AND HIGH SCAN PERFORMANCE filed Mar. 11, 2024, which is a continuation of U.S. patent application Ser. No. 17/716,625 entitled ARRAY LATTICE TECHNIQUES FOR HIGH SYMMETRY AND HIGH SCAN PERFORMANCE filed Apr. 8, 2022, which claims the benefit of U.S. Provisional Patent Application No. 63/173,120 entitled ARRAY LATTICE TECHNIQUES FOR HIGH SYMMETRY AND HIGH SCAN PERFORMANCE filed Apr. 9, 2021, each of which is incorporated herein by reference in its entirety.

### FIELD

The present disclosure generally relates to increasing element offset in phased arrays.

### BACKGROUND

Active Electronically Scanned Arrays (AESAs) are a desirable antenna topology for wireless communication systems where a wireless system must achieve a link in multiple different directions. One example of the use of an AESA is a cell phone base station communicating with users at various locations. AESAs are made up of many individual antenna elements, resulting in high antenna directivity, and each element or subset of elements can be individually controlled to scan or focus energy in a desired direction. The maximum directivity an AESA can exhibit is proportional to the physical size of the aperture. Increased directivity allows for wireless links to be made over longer distances, or at higher modulation orders, meaning faster data rates. Of course, the same could be achieved by increasing the power on the transmit side of the link, but power is not free and is often fixed per the specifications of the system. Increasing the aperture size improves system performance at minimal cost.

### SUMMARY

Disclosed is a novel approach to increase the antenna aperture of an AESA using a split-feed antenna element with staggered columns in the array. The staggered columns are referred to as element offset. Increased element offset between the staggered columns can provide increased directivity and lower grating lobes across a given scan volume. Further improvement can be made by properly spacing the two individual elements that make up a single split feed element.

One general aspect includes a phased antenna array. The phased antenna array includes a plurality of split element unit cells arranged in an array having at least one row of split element unit cells, each row arranged relative to a horizontal row axis, where each split element unit cell may include two split-fed antennas arranged substantially along a vertical column axis substantially normal to the row axis and having a phase center substantially along the column axis between the two split-fed antennas. The column axes of the split element unit cells of each row are substantially parallel. The phase center of each split element unit cell in a row is offset vertically from the phase center of an adjacent split element unit cell in the row by more than half of a single element unit cell up to and including 1.5 element unit cells.

Implementations may include one or more of the following features. In some embodiments, the array is a one-dimensional array having one row of split element unit cells. In some embodiments, the array is a two-dimensional array having at least two rows of split element unit cells. In some embodiments, a distance between the two antennas of a split element unit cell is configured to tailor the array to have an optimal directivity for a given scan volume, including a placement of nulls where grating lobes will appear during elevation scans. In some embodiments, the distance between the two antennas of a split element unit cell is decreased relative to a nominal distance. In some embodiments, the distance between the two antennas of a split element unit cell is increased relative to a nominal distance.

One general aspect includes a method of steering a beam with a phased array. The method of steering includes a plurality of split element unit cells having at least one row of split element unit cells, each row arranged relative to a horizontal row axis, where each split element unit cell may include two split-fed antennas arranged substantially along a vertical column axis substantially normal to the row axis and having a phase center substantially along the column axis between the two split-fed antennas. The column axes of the split element unit cells of each row are substantially parallel. The phase center of each split element unit cell in a row is offset vertically from the phase center of an adjacent split element unit cell in the row by more than half of a single element unit cell up to and including 1.5 element unit cells. The method may include, with an antenna controller: calculating beam steering vectors for the phased array; and with the beam steering vectors, controlling the plurality of split element unit cells.

Implementations may include one or more of the following features. In some embodiments, the array is a one-dimensional array having one row of split element unit cells. In some embodiments, the array is a two-dimensional array having at least two rows of split element unit cells. In some embodiments, a distance between the two antennas of a split element unit cell is configured to tailor the array to have an optimal directivity for a given scan volume, including a placement of nulls where grating lobes will appear during elevation scans. In some embodiments, the distance between the two antennas of a split element unit cell is decreased relative to a nominal distance. In some embodiments, the distance between the two antennas of a split element unit cell is increased relative to a nominal distance.

One general aspect includes a wireless device including a phased antenna array. The phased antenna array includes: a plurality of split element unit cells arranged in an array having at least one row of split element unit cells, each row arranged relative to a horizontal row axis, where each split element unit cell may include two split-fed antennas arranged substantially along a vertical column axis substantially normal to the row axis and having a phase center substantially along the column axis between the two split-fed antennas, where the column axes of the split element unit cells of each row are substantially parallel, and where the phase center of each split element unit cell in a row is offset vertically from the phase center of an adjacent split element unit cell in the row by more than half of a single element unit cell up to and including 1.5 element unit cells.

Implementations may include one or more of the following features. In some embodiments, the array is a one-dimensional array having one row of split element unit cells. In some embodiments, the array is a two-dimensional array having at least two rows of split element unit cells. In some embodiments, a distance between the two antennas of a split element unit cell is configured to tailor the array to have an optimal directivity for a given scan volume, including a placement of nulls where grating lobes will appear during elevation scans. In some embodiments, the distance between the two antennas of a split element unit cell is decreased relative to a nominal distance. In some embodiments, the distance between the two antennas of a split element unit cell is increased relative to a nominal distance.

### BRIEF DESCRIPTION OF THE DRAWINGS

Those skilled in the art should more fully appreciate advantages of various embodiments from the following “Description of Illustrative Embodiments,” discussed with reference to the drawings summarized immediately below.

FIG. 1 schematically shows an active electronically steered element system (“AESA system”) configured in accordance with illustrative embodiments and communicating with a satellite.

FIGS. 2A and 2B schematically show generalized diagrams of an AESA system that may be configured in accordance with illustrative embodiments, where FIG. 2A schematically shows a block diagram of the AESA system, while FIG. 2B schematically shows a cross-sectional view of a small portion of the same AESA system across line B-B.

FIG. 3A schematically shows a plan view of a laminar printed circuit board portion of an AESA configured in accordance with illustrative embodiments.

FIG. 3B schematically shows a close-up of a portion of the laminated printed circuit board of FIG. 3A.

FIG. 4 is a schematic diagram showing scan volume for a phased array.

FIG. 5 is a schematic diagram showing direct feed and split feed element designs.

FIG. 6 is a schematic diagram showing split feed elements with an offset column design.

FIG. 7 is a schematic diagram showing split feed elements with increased offset column spacing.

FIG. 8 is a schematic diagram showing split feed elements with adjusted antenna-to-antenna spacing.

FIG. 9 is a schematic diagram showing split feed elements with increased offset column spacing.

It should be noted that the foregoing figures and the elements depicted therein are not necessarily drawn to consistent scale or to any scale. Unless the context otherwise suggests, like elements are indicated by like numerals. The drawings are primarily for illustrative purposes and are not intended to limit the scope of the inventive subject matter described herein.

### DESCRIPTION OF ILLUSTRATIVE EMBODIMENTS

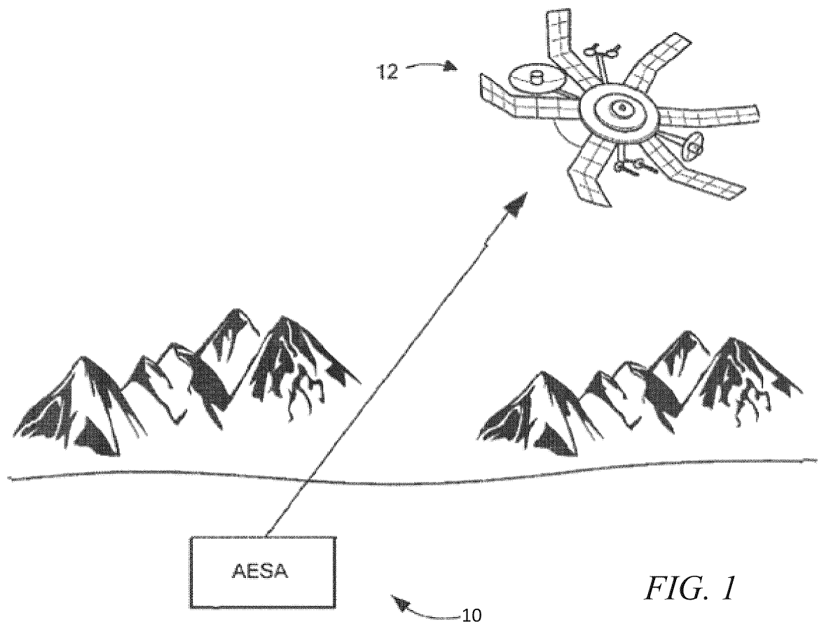

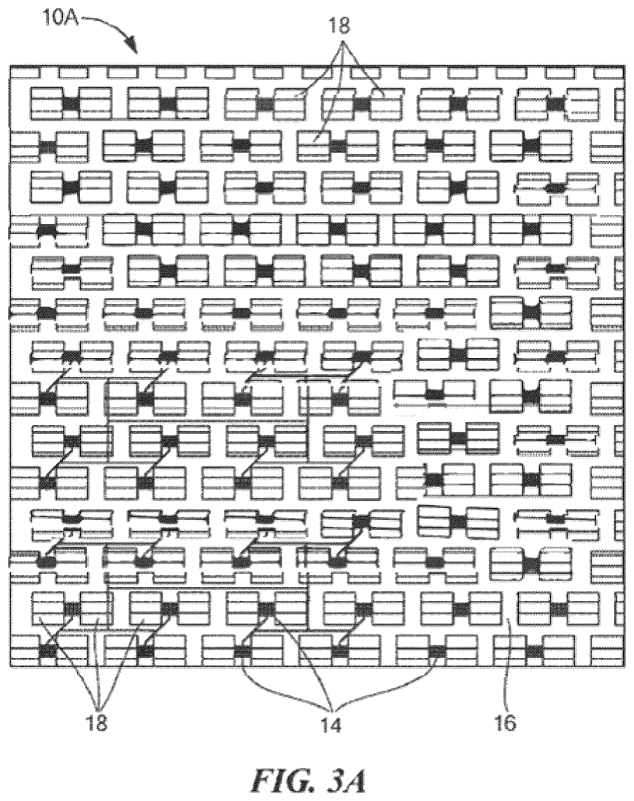

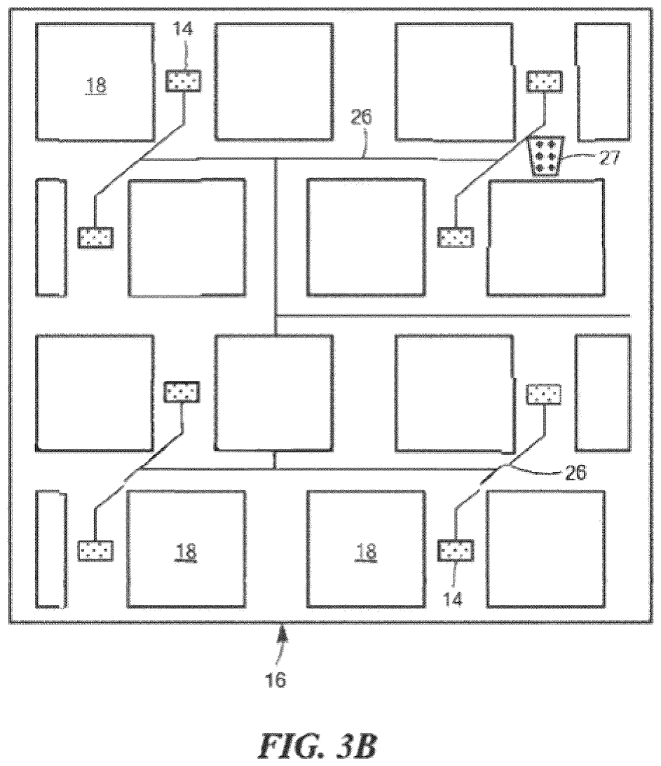

FIG. 1 schematically shows an active electronically steered antenna system (“AESA system 10”) or wireless device configured in accordance with illustrative embodiments and communicating with an orbiting satellite 12. A phased array (discussed below and identified by reference number “10A”—see FIG. 3A) implements the primary functionality of the AESA system 10. Specifically, as known by those skilled in the art, the phased array forms one or more of a plurality of electronically steerable beams that can be used for a wide variety of applications. As a satellite communication system, for example, the AESA system 10 preferably is configured to operate at one or more satellite frequencies. Among others, those frequencies may include the Ka-band, Ku-band, and/or X-band.

The satellite communication system may be part of a cellular network operating under a known cellular protocol, such as the 3G, 4G, or 5G protocols. Accordingly, in addition to communicating with satellites, the system may communicate with earth-bound devices, such as smartphones or other mobile devices, using any of the 3G, 4G, or 5G protocols. As another example, the satellite communication system may transmit/receive information between aircraft and air traffic control systems. Of course, those skilled in the art may use the AESA system 10 (e.g., implementing a phased array 10A as shown in FIG. 3A) in a wide variety of other applications, such as broadcasting, optics, radar, etc. Some embodiments may be configured for non-satellite communications and instead communicate with other devices, such as smartphones (e.g., using 4G, 5G, or WLAN protocols). Accordingly, discussion of communication with orbiting satellites 12 is not intended to limit all embodiments.

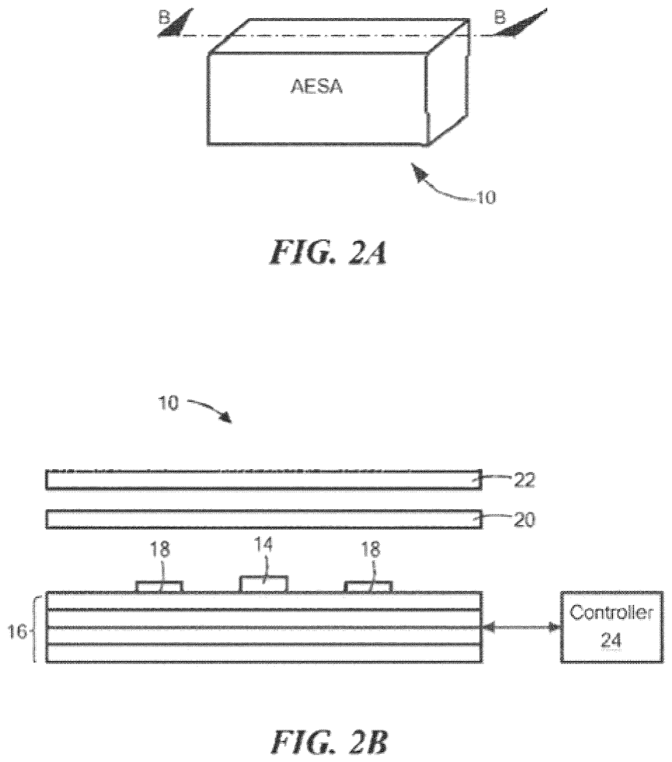

FIGS. 2A and 2B schematically show generalized diagrams of the AESA system 10 configured in accordance with illustrative embodiments. Specifically, FIG. 2A schematically shows a block diagram of the AESA system 10, while FIG. 2B schematically shows a cross-sectional view of a small portion of the same AESA system 10 across line B-B. This latter view shows a single silicon integrated circuit 14 mounted onto a substrate 16 between two transmit, receive, and/or dual transmit/receive elements 18, i.e., on the same side of a supporting substrate 16 and juxtaposed with the two elements 18. Note that in some embodiments, such as some implementing cellular communications, the integrated circuit 14 can be coupled with four elements 18. In alternative embodiments, however, the integrated circuit 14 could be on the other side/surface of the substrate 16A. The AESA system 10 also has a radome 20, 22 to environmentally protect the phased array of the system 10. A separate antenna controller 24 (FIG. 2B) electrically connects with the phased array to calculate beam steering vectors for the overall phased array, and to provide other control functions.

FIG. 3A schematically shows a plan view of a primary portion of an AESA system 10 that may be configured in accordance with illustrative embodiments. In a similar manner, FIG. 3B schematically shows a close-up of a portion of the phased array 10A of FIG. 3A.

Specifically, the AESA system 10 of FIG. 3A is implemented as a laminar phased array 10A having a laminated printed circuit board 16 (i.e., acting as the substrate for routing signals and also identified by reference number “16”) supporting the above noted plurality of antenna elements 18 and integrated circuits 14. The elements 18 preferably are formed as a plurality of patch antennas oriented in a triangular patch array configuration. In other words, each element 18 forms a triangle with two other adjacent elements 18. When compared to a rectangular lattice configuration, this triangular lattice configuration requires fewer elements 18 (e.g., about 15 percent fewer in some implementations) for a given grating lobe free scan volume. Other embodiments, however, may use other lattice configurations, such as a pentagonal configuration or a hexagonal configuration. Moreover, despite requiring more elements 18, some embodiments may use a rectangular lattice configuration. Like other similar phased arrays, the printed circuit board 16 also may have a ground plane (not shown) that electrically and magnetically cooperates with the elements 18 to facilitate operation.

Indeed, the array shown in FIGS. 3A and 3B is a small phased array 10A. Those skilled in the art can apply principles of illustrative embodiments to laminar phased arrays 10A with hundreds, or even thousands of elements 18 and integrated circuits 14. In a similar manner, those skilled in the art can apply various embodiments to smaller phased arrays 10A.

As a patch array, the elements 18 may have a low profile. Specifically, as known by those skilled in the art, a patch antenna (i.e., the element 18 or the transmission/receiving part of the element) typically is mounted on a flat surface and includes a flat rectangular sheet of metal (known as the patch and noted above) mounted over a larger sheet of metal known as a “ground plane.” A dielectric layer between the two metal regions electrically isolates the two sheets to prevent direct conduction. When energized, the patch and ground plane together produce a radiating electric field and/or receive RF signals.

As noted above and discussed in greater detail below, illustrative embodiments form the patch antennas on one or more printed circuit boards that themselves are coupled with the printed circuit board 16. These patch antennas preferably are formed using standard printed circuit board fabrication processes, thus complying with standard printed circuit board design rules (discussed below). Accordingly, using such fabrication processes, each element 18 in the phased array 10A may have a very low profile.

The phased array 10A can have one or more of any of a variety of different functional types of elements 18. For example, the phased array 10A can have transmit-only elements 18, receive-only elements 18, and/or dual mode receive and transmit elements 18 (referred to as “dual-mode elements 18”). The transmit-only elements 18 are configured to transmit outgoing signals (e.g., burst signals) only, while the receive-only elements 18 are configured to receive incoming signals only. In contrast, the dual-mode elements 18 are configured to either transmit outgoing burst signals, or receive incoming signals, depending on the mode of the phased array 10A at the time of the operation. Specifically, when using dual-mode elements 18, the phased array 10A can be in either a transmit mode, or a receive mode. The noted controller 24 (see FIG. 2B) at least in part controls the mode and operation of the phased array 10A, as well as other array functions.

The AESA system 10 may have a plurality of the above noted integrated circuits 14 (mentioned above with regard to FIG. 2B) for controlling operation of the elements 18. Those skilled in the art often refer to these integrated circuits 14 as “beam steering integrated circuits,” or “beam forming integrated circuits.”

Each integrated circuit 14 preferably is configured with at least the minimum number of functions to accomplish the desired effect. Indeed, integrated circuits 14 for dual mode elements 18 are expected to have some different functionality than that of the integrated circuits 14 for the transmit-only elements 18 or receive-only elements 18. Accordingly, integrated circuits 14 for such non-dual-mode elements 18 typically have a smaller footprint than the integrated circuits 14 that control the dual-mode elements 18. Despite that, some or all types of integrated circuits 14 fabricated for the phased array 10A can be modified to have a smaller footprint.

As an example, depending on its role in the phased array 10A, each integrated circuit 14 may include some or all of the following functions:
phase shifting,
amplitude controlling/beam weighting,
switching between transmit mode and receive mode,
output amplification to amplify output signals to the elements 18,
input amplification for received RF signals (e.g., signals received over 4G, 5G, or WLAN), and
power combining/summing and splitting between elements 18.

Indeed, some embodiments of the integrated circuits 14 may have additional or different functionality, although illustrative embodiments are expected to operate satisfactorily with the above noted functions. Those skilled in the art can configure the integrated circuits 14 in any of a wide variety of manners to perform those functions. For example, the input amplification may be performed by a low noise amplifier, the phase shifting may use conventional active phase shifters, and the switching functionality may be implemented using conventional transistor-based switches.

Each integrated circuit 14 preferably operates on at least one element 18 in the array. For example, one integrated circuit 14 can operate on two or four different elements 18. Of course, those skilled in the art can adjust the number of elements 18 sharing an integrated circuit 14 based upon the application. For example, a single integrated circuit 14 can control two elements 18, three elements 18, five elements 18, six elements 18, seven elements 18, eight elements 18, etc., or some range of elements 18. Sharing the integrated circuits 14 between multiple elements 18 in this manner reduces the required total number of integrated circuits 14, correspondingly sometimes enabling a reduction in the required size of the printed circuit board 16.

As noted above, the dual-mode elements 18 may operate in a transmit mode, or a receive mode. To that end, the integrated circuits 14 may generate time division diplex or duplex waveforms so that a single aperture or phased array 10A can be used for both transmitting and receiving. In a similar manner, some embodiments may eliminate a commonly included transmit/receive switch in the side arms of the integrated circuit 14. Instead, such embodiments may duplex at the element 18. This process can be performed by isolating one of the elements 18 between transmit and receive by an orthogonal feed connection.

RF interconnect, through-vias, and/or beam forming lines 26 (see FIG. 3B) electrically connect the integrated circuits 14 to their respective elements 18. To further minimize the feed loss, illustrative embodiments mount the integrated circuits 14 as close to their respective elements 18 as possible. Specifically, this close proximity preferably reduces RF interconnect line lengths, reducing the feed loss. To that end, each integrated circuit 14 preferably is packaged either in a flip-chipped configuration using wafer level chip scale packaging (WLCSP), or a traditional package, such as quad flat no-leads package (QFN package). While other types of packaging may suffice, WLCSP techniques may be preferred to minimize real estate on the substrate 16A. Some embodiments may mount some or all of the integrated circuits 14 on or within the printed circuit boards forming the elements 18. Other embodiments may mount some or all of the integrated circuits 14 on the underlying routing substrate board 16.

In addition to reducing feed loss, using WLCSP techniques reduces the overall footprint of the integrated circuits 14, enabling them to be mounted on the top face of the printed circuit board 16 with the elements 18—providing more surface area for the elements 18. Other embodiments mount the integrated circuits 14 of one side and the elements 18 on the other side.

It should be reiterated that although FIGS. 3A and 3B show the AESA system 10 with some specificity (e.g., the layout of the elements 18 and integrated circuits 14), those skilled in the art may apply illustrative embodiments to other implementations. For example, as noted above, each integrated circuit 14 can connect to more or fewer elements 18, or the lattice configuration can be different. Accordingly, discussion of the specific configuration of the AESA system 10 of FIG. 3A (and other figures) is for convenience only and not intended to limit all embodiments.

In phased arrays that require full hemisphere scan capability, element spacing must be kept below a half wavelength to avoid grating lobes, which are undesired and typically reduce directivity. Many phased arrays, however, do not require full hemisphere scanning, and therefore element spacing can be increased without introducing grating lobes.

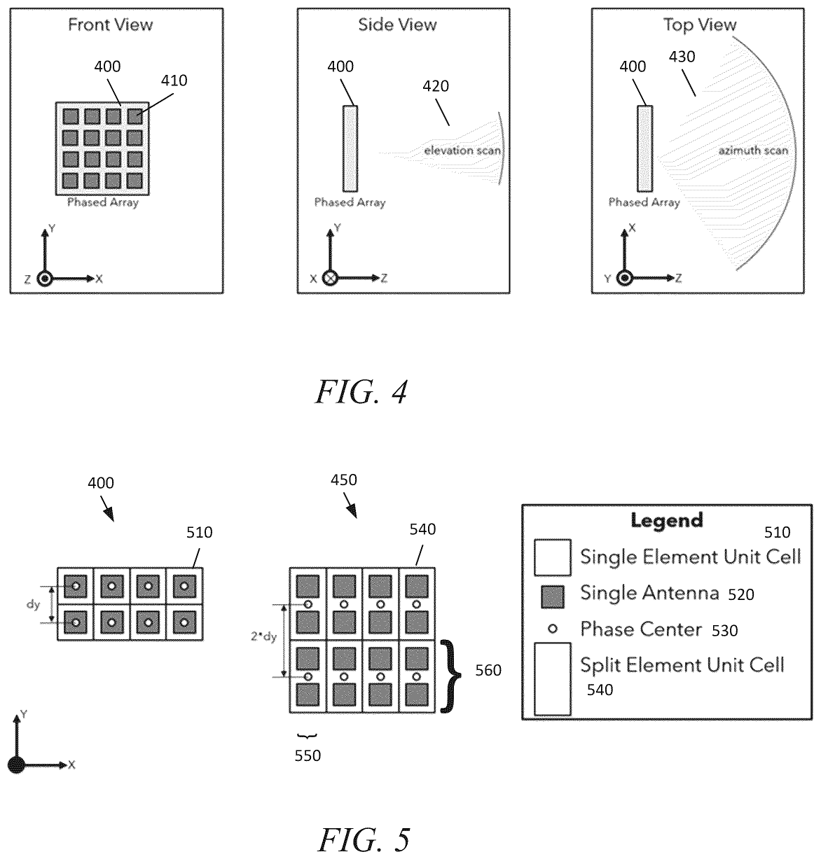

Communication systems commonly require less scanning in elevation compared to azimuth. FIG. 4 schematically shows a phased array 400 of antenna elements 410, and the associated scan volume for a typical communication system with limited elevation scan 420 and/or azimuth scan 430.

For these applications, a split feed antenna element can be used, which results in higher directivity for the phased array due to higher element directivity as well as increased total aperture area of the array. FIG. 5 schematically shows an 8-channel phased array 400 with direct feed and an 8-channel phased array 450 with split feed element designs. In the example shown in FIG. 5, the array comprises four columns 550 and two rows 560, although myriad other arrangements are possible and fall within the scope of the present disclosure. For a split feed element design, a power combiner/splitter may be used to feed two antenna elements 520 with a single RF channel (e.g., a transmit signal may be split and fed to two antenna elements 520, while signals received at two antenna elements 520 may be combined into a single receive signal for processing). It should be noted that embodiments are not limited to 8 or to any particular number of channels.

In a single element unit cell 510, the phase center 530 may occur in or near the center of each single antenna or antenna element 520. In a split element unit cell 540, the phase center 530 may occur in the space between two antenna elements 520.

The use of split feed elements is often combined with offsetting half of the columns of elements in the array, helping to minimize the impact of grating lobes.

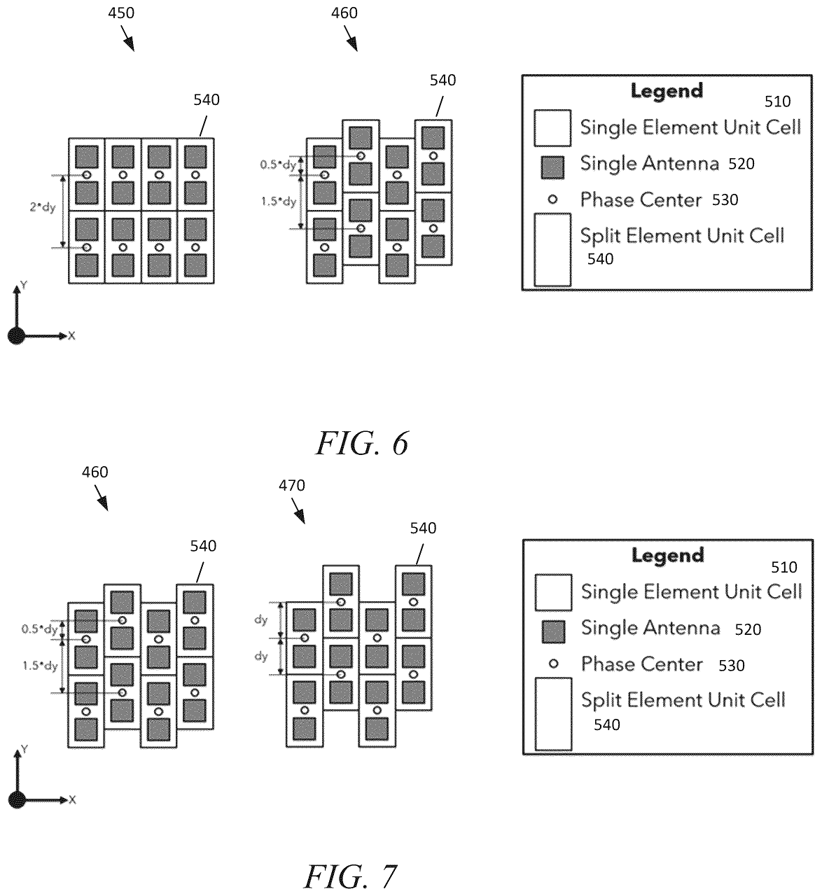

FIG. 6 schematically shows a phased array 450 using split feed elements with even columns and a phased array 460 with offset columns. The offset may be equal to or less than one half of a dimension of a single element unit cell 510 (e.g., equal to or less than one quarter of a dimension of a split element unit cell 540, which may correspond to less than or equal to a half wavelength of offset). In the specific example shown in FIG. 6, the offset between columns is chosen to be half of the element unit cell. This type of phased array is commonly used in communication systems with limited elevation scan requirements.

Certain embodiments further increase the offset in half of the array columns beyond half of a unit cell, and up to a full unit cell.

FIG. 7 schematically shows a phased array 460 using split feed elements with the typical column spacing of one half of a single element unit cell 510 as in FIG. 6, and a phased array 470 with increased offset columns of more than half of a single element unit cell 510 up to and including 1.5 single element unit cells 510 as depicted in FIG. 6. The result of increasing the offset in y-spacing of the array may be that the maximum spacing of split element phase centers decreases, which can lead to reduced grating lobes. This allows the y-spacing of the array lattice to be further increased, which can lead to increased directivity across a given scan volume.

Certain embodiments additionally or alternatively adjust the antenna-to-antenna spacing within each split element unit cell.

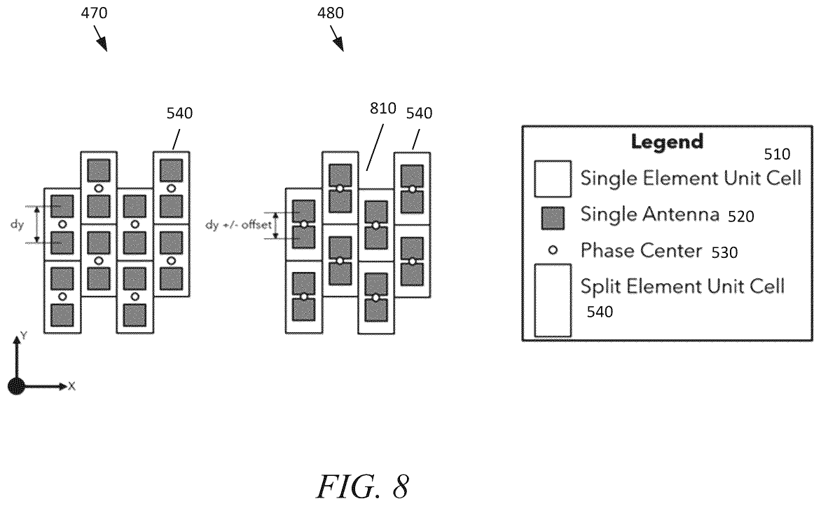

FIG. 8 schematically shows a phased array 470 using split feed elements with standard antenna-to-antenna spacing, and an example phased array 480 showing how the antenna-to-antenna spacing within a split element unit cell 540 can be adjusted which in this example is reduced (i.e., negative) antenna-to-antenna spacing in each split feed element. The offset can be positive or negative depending on the scan requirement and lattice design. This technique can be used to tailor the element pattern to have the optimal directivity, including the placement of nulls, for a given scan volume, and this tailoring can be based at least in part on the amount of vertical offset of the split element unit cells (which can be from zero to one full single element unit cell).

Using increased offset columns and/or adjusted antenna-to-antenna spacing, phased array directivity can be increased, e.g., due to a larger aperture size. Also, grating lobes can be decreased, e.g., due to a more uniform spacing between the phase centers of each split feed antenna element.

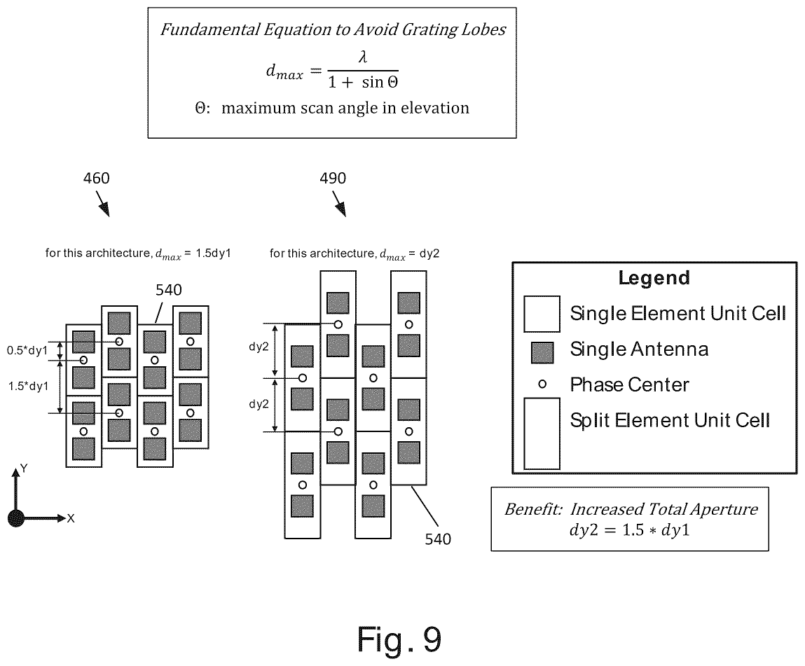

FIG. 9 schematically shows a phased array 460 using split feed elements with the typical column spacing of one half of a single element unit cell 510 as in FIG. 6, and a phased array 490 with increased offset columns of 1.5 times of a single element unit cell 510. The result of increasing the offset in y-spacing of the array may be that the maximum spacing of split element phase centers decreases, which can lead to reduced grating lobes. This allows the y-spacing of the array lattice to be further increased, which can lead to increased directivity across a given scan volume. The phased array with full element offset has an expanded lattice and thus increased total aperture, while maintaining the same maximum spacing between phase centers to avoid grating lobes.

These design techniques are particularly applicable to phased array antenna with a limited elevation scan requirement that uses a split feed antenna element with half of the columns of the array lattice offset from one another, e.g., to further increase the column offset, further increase the lattice size, and/or fine tune the spacing between the antenna elements sharing a split feed to place nulls in the element radiation pattern where grating lobes are expected in the array factor.

Thus, embodiments can include a phased array using a split feed element design having increased y-spacing beyond 0.5 patch-unit-cells and up to and including 1.5 patch-unit-cells.

Embodiments also can include a phased array using a split feed element design having increased or decreased y-spacing between patches shared by a split feed element, with or without increased y-spacing.

Embodiments also can include a phased array using split feed element design having both (a) increasing the y-spacing beyond 0.5 patch-unit-cells and up to and including 1.5 patch-unit-cells and (b) increasing or decreasing the y-spacing between patches shared by a split feed element.

Embodiments also can include a phased antenna array comprising a plurality of split element unit cells arranged in an array having at least one row of split element unit cells, each row arranged relative to a horizontal row axis, wherein each split element unit cell comprises two split-fed antennas arranged substantially along a vertical column axis substantially normal to the row axis and having a phase center substantially along the column axis between the two split-fed antennas, wherein the column axes of the split element unit cells of each row are substantially parallel, and wherein the phase center of each split element unit cell in a row is offset vertically from the phase center of an adjacent split element unit cell in the row by more than half of a single element unit cell up to and including 1.5 single element unit cells. In various alternative embodiments, the distance between the two antennas of a split element unit cell could be configured to tailor the element pattern to have the optimal directivity, including the placement of nulls 810, for a given scan volume (e.g., the distance between the two antennas of a split element unit cell may be decreased or increased relative to a nominal distance).

Embodiments also can include a phased antenna array comprising a plurality of split element unit cells arranged in an array having at least one row of split element unit cells, each row arranged relative to a horizontal row axis, wherein each split element unit cell comprises two split-fed antennas arranged substantially along a vertical column axis substantially normal to the row axis and having a phase center substantially along the column axis between the two split-fed antennas, wherein the column axes of the split element unit cells of each row are substantially parallel, and wherein the distance between the two antennas of a split element unit cell is configured to tailor the element pattern to have the optimal directivity, including the placement of nulls, for a given scan volume (e.g., the distance between the two antennas of a split element unit cell may be decreased or increased relative to a nominal distance). In various alternative embodiments, the phase center of each split element unit cell in a row may be offset vertically from the phase center of an adjacent split element unit cell in the row by up to and including 1.5 single element unit cells (e.g., by more than half of a single element unit cell up to and including 1.5 single element unit cells.

In any of the above-described embodiments, the array could be a one-dimensional array (e.g., linear) or could be at least part of a two-dimensional array (e.g., square, rectangular, triangular, circular, etc.). It should be noted here that certain types of two-dimensional arrays (e.g., triangular and circular, in particular) may have one or more rows containing only one split element unit cell.

It should be noted here that terms such as “horizontal” and “vertical” are not intended to refer to any specific direction or orientation other than relative to one another, e.g., a vertical axis being substantially normal to a horizontal axis regardless of the orientation of these axis relative to other frames of reference.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Various inventive concepts may be embodied as one or more methods, of which examples have been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein in the specification and in the claims, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Various embodiments of the present disclosure may be characterized by the potential claims listed in the paragraphs following this paragraph (and before the actual claims provided at the end of the application). These potential claims form a part of the written description of the application. Accordingly, subject matter of the following potential claims may be presented as actual claims in later proceedings involving this application or any application claiming priority based on this application. Inclusion of such potential claims should not be construed to mean that the actual claims do not cover the subject matter of the potential claims. Thus, a decision to not present these potential claims in later proceedings should not be construed as a donation of the subject matter to the public. Nor are these potential claims intended to limit various pursued claims.

Without limitation, potential subject matter that may be claimed (prefaced with the letter “P” so as to avoid confusion with the actual claims presented below) includes:

P1. For a phased array using a split feed element design, increasing the y-spacing beyond 0.5 patch-unit-cells and up to and including 1.5 patch-unit-cells.

P2. For a phased array using a split feed element design, increasing or decreasing the y-spacing between patches shared by a split feed element, with or without increased y-spacing.

P3. For a phased array using split feed element design, both (a) increasing the y-spacing beyond 0.5 patch-unit-cells and up to and including 1.5 patch-unit-cells and (b) increasing or decreasing the y-spacing between patches shared by a split feed element.

Although the above discussion discloses various exemplary embodiments, it should be apparent that those skilled in the art can make various modifications that will achieve some of the advantages of the present disclosure without departing from the true scope of the present disclosure. Any references to the “present disclosure” are intended to refer to exemplary embodiments of the disclosure and should not be construed to refer to all embodiments unless the context otherwise requires. The described embodiments are to be considered in all respects only as illustrative and not restrictive.

What is claimed is:

1. A phased antenna array, comprising:
a plurality of split element unit cells arranged in an array having at least one row of split element unit cells, each row arranged relative to a horizontal row axis, wherein each split element unit cell comprises two split-fed antennas arranged substantially along a vertical column axis substantially normal to the row axis and having a phase center substantially along the column axis between the two split-fed antennas,
wherein the column axes of the split element unit cells of each row are substantially parallel, and
wherein the phase center of each split element unit cell in a row is offset vertically from the phase center of an adjacent split element unit cell in the row by more than half of a single element unit cell up to and including a 1.5 element unit cells.

2. The phased antenna array of claim 1, wherein the array is a one-dimensional array having one row of split element unit cells.

3. The phased antenna array of claim 1, wherein the array is a two-dimensional array having at least two rows of split element unit cells.

4. The phased antenna array of claim 1, wherein a distance between the two antennas of a split element unit cell is configured to tailor the array to have an optimal directivity for a given scan volume, including a placement of nulls where grating lobes will appear during elevation scans.

5. The phased antenna array of claim 4, wherein the distance between the two antennas of a split element unit cell is decreased relative to a nominal distance.

6. The phased antenna array of claim 4, wherein the distance between the two antennas of a split element unit cell is increased relative to a nominal distance.

7. A method of steering a beam with a phased array, the array comprising:
a plurality of split element unit cells having at least one row of split element unit cells, each row arranged relative to a horizontal row axis, wherein each split element unit cell comprises two split-fed antennas arranged substantially along a vertical column axis substantially normal to the row axis and having a phase center substantially along the column axis between the two split-fed antennas,
wherein the column axes of the split element unit cells of each row are substantially parallel, and
wherein the phase center of each split element unit cell in a row is offset vertically from the phase center of an adjacent split element unit cell in the row by more than half of a single element unit cell up to and including 1.5 element unit cells,
the method comprising, with an antenna controller:
calculating beam steering vectors for the phased array; and
with the beam steering vectors, controlling the plurality of split element unit cells.

8. The method of claim 7, wherein the array is a one-dimensional array having one row of split element unit cells.

9. The method of claim 7, wherein the array is a two-dimensional array having at least two rows of split element unit cells.

10. The method of claim 7, wherein a distance between the two antennas of a split element unit cell is configured to tailor the array to have an optimal directivity for a given scan volume, including a placement of nulls where grating lobes will appear during elevation scans.

11. The method of claim 10, wherein the distance between the two antennas of a split element unit cell is decreased relative to a nominal distance.

12. The method of claim 10, wherein the distance between the two antennas of a split element unit cell is increased relative to a nominal distance.

13. A wireless device comprising:
a phased antenna array, comprising:
a plurality of split element unit cells arranged in an array having at least one row of split element unit cells, each row arranged relative to a horizontal row axis, wherein each split element unit cell comprises two split-fed antennas arranged substantially along a vertical column axis substantially normal to the row axis and having a phase center substantially along the column axis between the two split-fed antennas,
wherein the column axes of the split element unit cells of each row are substantially parallel, and
wherein the phase center of each split element unit cell in a row is offset vertically from the phase center of an adjacent split element unit cell in the row by more than half of a single element unit cell up to and including 1.5 element unit cells.

14. The wireless device of claim 13, wherein the array is a one-dimensional array having one row of split element unit cells.

15. The wireless device of claim 13, wherein the array is a two-dimensional array having at least two rows of split element unit cells.

16. The wireless device of claim 13, wherein a distance between the two antennas of a split element unit cell is configured to tailor the array to have an optimal directivity for a given scan volume, including a placement of nulls where grating lobes will appear during elevation scans.

17. The wireless device of claim 16, wherein the distance between the two antennas of a split element unit cell is decreased relative to a nominal distance.

18. The wireless device of claim 16, wherein the distance between the two antennas of a split element unit cell is increased relative to a nominal distance.
